(19) United States
(12) Patent Application Publication
(10) Pub. No.: US 2017/0185366 A1
(43) Pub. Date: Jun. 29, 2017

(54) METHOD AND DEVICE FOR INPUTTING INFORMATION

(71) Applicant: Xiaomi Inc., Beijing (CN)

(72) Inventors: Xi WANG, Beijing (CN); Dian FAN, Beijing (CN); Daokuan LIU, Beijing (CN); Zengxiang LV, Beijing (CN); Xiaoyin LI, Beijing (CN)

(73) Assignee: Xiaomi Inc.

(21) Appl. No.: 15/389,518

(22) Filed: Dec. 23, 2016

(30) Foreign Application Priority Data
Dec. 24, 2015 (CN) 201510992593.9

(51) Int. Cl. G06F 3/14; H04B 7/155; G06F 3/0482; H04W 76/02

(52) U.S. Cl. CPC G06F 3/1454; H04W 76/02; H04B 7/155; G06F 3/0482

(57) ABSTRACT

The present disclosure relates to a method and device for inputting information. The method includes: establishing a network connection with a relay device; obtaining input information from the relay device, wherein the input information is received at an auxiliary input terminal and is sent from the auxiliary input terminal to the relay device; and displaying the input information at an input position on a main input terminal.

### CROSS-REFERENCE TO RELATED APPLICATIONS

The present application is based upon and claims priority to Chinese Patent Application No. 201510992593.9, filed Dec. 24, 2015, the entire contents of which are incorporated herein by reference.

### TECHNICAL FIELD

The present disclosure generally relates to computer application technologies, and more particularly, to a method and device for inputting information.

### BACKGROUND

With continuous development of mobile communications and electronic technologies, portable mobile terminals have become one of the indispensable tools in people's daily life. During the usage of mobile terminals, people usually need to use the mobile terminals to input some information.

In related arts, if a user wants to enter information into a mobile terminal, the user may tap at a position on a screen of the mobile terminal where the user wants to enter information. At this time, the mobile terminal changes to a state for accepting input, and meanwhile displays an input interface including a virtual keyboard, by which the user can input information. Due to the small size of the screen of the mobile terminal, the size of the virtual keyboard is limited, thereby resulting in low efficiency in user input.

### SUMMARY

According to a first aspect of embodiments of the present disclosure, there is provided a method for inputting information, including: establishing a network connection with a relay device; obtaining input information from the relay device, wherein the input information is received at an auxiliary input terminal and is sent from the auxiliary input terminal to the relay device; and displaying the input information at an input position on a main input terminal.

According to a second aspect of embodiments of the present disclosure, there is provided a device for inputting information, including: a processor; and a memory for storing instructions executable by the processor; wherein the processor is configured to: establish a network connection with a relay device; obtain input information from the relay device, wherein the input information is received at an auxiliary input terminal and is sent from the auxiliary input terminal to the relay device; and display the input information at an input position on a main input terminal.

According to a third aspect of embodiments of the present disclosure, there is provided a non-transitory computer-readable storage medium having stored therein instructions that, when executed by a processor of a main input terminal, cause the main input terminal to perform a method for inputting information, the method including: establishing a network connection with a relay device; obtaining input information from the relay device, wherein the input information is received at an auxiliary input terminal and is sent from the auxiliary input terminal to the relay device; and displaying the input information at an input position on a main input terminal.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram showing an implementation environment for a method for inputting information, according to an exemplary embodiment.

FIG. 2 is a flow chart of a method for inputting information, according to an exemplary embodiment.

FIG. 3 is a flow chart of a method for inputting information, according to another exemplary embodiment.

FIG. 4 is a flow chart of a method for inputting information, according to another exemplary embodiment.

FIG. 5 is a block diagram of a device for inputting information, according to an exemplary embodiment.

FIG. 6 is a block diagram of a device for inputting information, according to another exemplary embodiment.

FIG. 7 is a block diagram of a device for inputting information, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

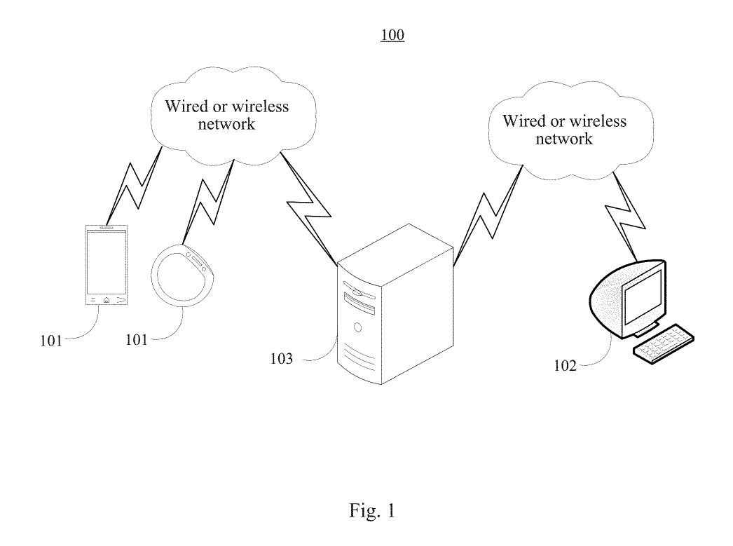

FIG. 1 is a schematic diagram showing an implementation environment 100 for a method for inputting information according to an embodiment of the present disclosure. The implementation environment 100 can include at least one main input terminal 101, an auxiliary input terminal 102, and a relay device 103.

In exemplary embodiments, the main input terminal 101 can be an electronic device such as a mobile phone, a wearable device, a smart TV, or a vehicle-mounted terminal. In the exemplary embodiments, one or more application programs having an information inputting function (for example, application programs for inputting characters) are installed in the main input terminal 101.

In exemplary embodiments, the auxiliary input terminal 102 can be a device such as a personal computer (PC), a laptop, or a tablet.

The main input terminal 101 is connected with the relay device 103 via a wireless or wired network, and the auxiliary input terminal 102 is connected with the relay device 103 via a wireless or wired network.

In exemplary embodiments, the relay device 103 can be a server, or a host computer in a local area network, or a server cluster made up of a plurality of servers.

The technical solutions provided by embodiments of the present disclosure will be described and explained with the implementation environment 100 as shown in FIG. 1 as an example.

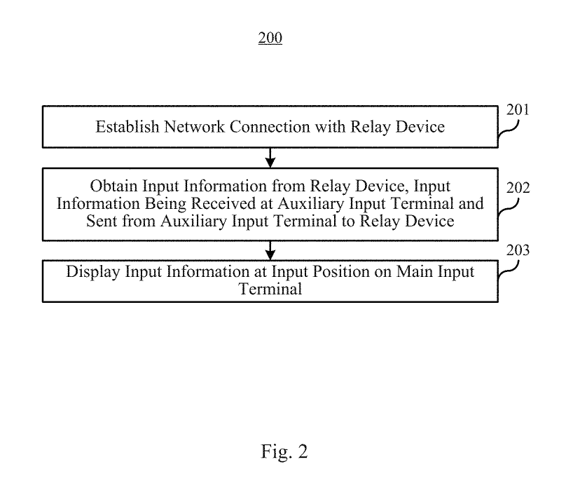

FIG. 2 is a flow chart of a method 200 for inputting information, according to an exemplary embodiment. For example, the method 200 can be performed by the main input terminal 101 of the implementation environment 100 described in connection with FIG. 1. The method 200 can include the following steps.

In step 201, a network connection with a relay device is established.

In step 202, input information is obtained from the relay device. The input information is received at an auxiliary input terminal and is sent from the auxiliary input terminal to the relay device.

In step 203, the input information is displayed at an input position on a main input terminal.

In the method 200, a network connection between a main input terminal and a relay device is established. The main input terminal obtains input information from the relay device. The input information is input into an auxiliary input terminal and is sent from the auxiliary input terminal to the relay device. The input information is displayed at an input position on the main input terminal. In this way, if the screen size of the main input terminal is relatively small or the input manner is not suitable for quick entering of information, a user can perform inputting in the auxiliary input terminal which supports convenient and fast input. The information input into the auxiliary input terminal can be automatically added to the input position in the main input terminal. Thus, input difficulties in the main input terminal are lowered, thereby improving efficiency in inputting information.

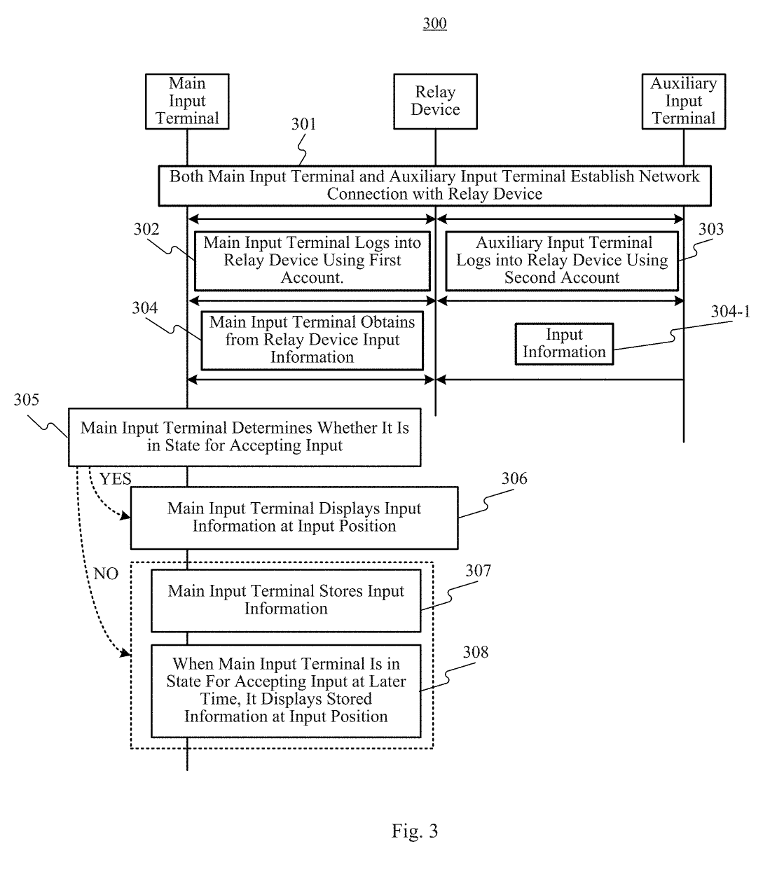

FIG. 3 is a flow chart of a method 300 for inputting information, according to another exemplary embodiment. For example, the method 300 can be applied in the implementation environment 100 described in connected with FIG. 1. Referring to FIG. 3, the method 300 can include the following steps.

In step 301, both the main input terminal and the auxiliary input terminal establish a network connection with the relay device.

The main input terminal and the auxiliary input terminal can each establish a wireless or wired network connection with the relay device.

In step 302, the main input terminal logs into the relay device using a first account.

In step 303, the auxiliary input terminal logs into the relay device using a second account.

The first account and the second account can be the same one, or the first account and the second account are bound or associated with each other in advance. According to an exemplary embodiment, the first account and the second account can each include a user name or an email address, or the like.

For example, applications (APPs) corresponding to the main input terminal and the auxiliary input terminal, respectively, can be downloaded and installed in advance.

In one embodiment, a user opens the APPs in the main input terminal and the auxiliary input terminal, respectively, and logs into the relay device using the same account. If the relay device detects that the main input terminal and the auxiliary input terminal log into the relay device using the same account, the relay device establishes a corresponding relationship between the main input terminal and the auxiliary input device.

In another embodiment, a user logs into the relay device through the main input terminal or the auxiliary input terminal using two accounts, and requests to bind or associate the two different accounts. Later, the user opens the APPs in the main input terminal and the auxiliary input terminal, respectively, and logs into the relay device using a first account, e.g., Adam1, and a second account, e.g., Adam2. If the relay device determines that Adam1 and Adam2 are two accounts which are bound or associated with each other, the relay device establishes a corresponding relationship between the main input terminal and the auxiliary input terminal.

In step 304, the main input terminal obtains from the relay device input information. The input information is received at an auxiliary input terminal and is sent from the auxiliary input terminal to the relay device (step 304-1).

When both the main input terminal and the auxiliary input terminal log into the relay device, information input into the auxiliary input terminal by the user can be obtained by the main input terminal. When the main input terminal obtains the input information from the relay device, the main input terminal can obtain the information character by character. For example, for each character input by the user into the auxiliary input terminal, the auxiliary input terminal sends the character to the relay device in real time, and the main input terminal can obtain the character immediately. Correspondingly, to delete one or more characters which have been input, for each character which is deleted by the user in the auxiliary input terminal, the auxiliary input terminal sends related deletion information to the relay device. After obtaining the deletion information from the relay device, the main input terminal deletes the obtained character. In one embodiment, the deletion information can be instruction information for indicating the character to be deleted, and the main input terminal device can delete the character to be deleted among the obtained characters according to the deletion information. In another embodiment, the deletion information can include the remaining characters after deletion of one character, and the main input terminal can replace the obtained characters with the remaining characters after deletion of one character as indicated by the deletion information.

In exemplary embodiments, when the main input terminal obtains the input information from the relay device, the main input terminal can obtain the information sentence by sentence. For example, after the user inputs a string of characters into the auxiliary input terminal, the user can tap or click a designated button (for example, a save button). After the auxiliary input terminal sends the string of characters to the relay device, the main input terminal can obtain the whole string of characters all at once.

In step 305, the main input terminal determines whether the main input terminal itself is in a state for accepting input. If the main input terminal is in the state for accepting input, step 306 is performed; if the main input terminal is not in the state for accepting input, steps 307 and 308 are performed.

In step 306, the main input terminal displays the input information at an input position on the main input terminal.

The input position refers to a position on the main input terminal where information can be added for display. For example, the input position can be a position on the main input terminal where a cursor flickers, or an input box on the main input terminal which is in an active state to receive input.

In step 307, the main input terminal stores the input information in the main input terminal.

In step 308, when the main input terminal is in the state for accepting input at a later time, the main input terminal displays the stored information to the input position on the main input terminal.

According to an exemplary embodiment, if the main input terminal is not in the state for accepting input when the main input terminal obtains the input information from the relay device, the main input terminal can cache the input information. When the main input terminal changes to the state for accepting input later, the main input terminal can display the cached information at the corresponding input position.

For example, the main input terminal is a smart phone, the auxiliary input terminal is a personal computer, and the relay device is a server. The user installs an APP into each of the smart phone and the personal computer. The APP can be an APP corresponding to the server. The user finishes login using a login page/interface of the APP in the smart phone and in the personal computer with the same account. At this time, the server can detect that the login accounts corresponding to the smart phone and the personal computer are the same one, and establishes a corresponding relationship between the smart phone and the personal computer. After the user finishes the login using the APP in the personal computer, the interface of the APP can show an input box, into which the user can input information.

In exemplary embodiments, each time after the user inputs one character, the personal computer sends the character to the server. After obtaining the character, the smart phone can display the obtained character at the input position if the smart phone is in the state for accepting input. Or the smart phone can cache the obtained character if the smart phone is not in the state for accepting input. When the smart phone changes to the state for accepting input at a later time, the smart phone can display the cached characters at the input position all at once. If the user deletes one character, the personal computer sends corresponding deletion information to the server. After obtaining the deletion information from the server, the smart phone deletes the character at the input position or in the cache as indicated by the deletion information.

In exemplary embodiments, each time after the user input a string of characters into the personal computer and taps or clicks a save button, the personal computer sends the whole string of characters to the server. After obtaining the whole string of characters from the server, the smart phone displays the whole string of characters at the input position or caches the whole string of characters. If the user modifies the saved whole string of characters (for example, addition or deletion of one of more characters), the personal computer sends the modified whole string of characters to the server after the user taps or clicks the save button again. After obtaining the modified whole string of characters, the smart phone replaces the characters at the input position or in the cache with the modified whole string of characters.

In the method 300, a network connection between a main input terminal and a relay device is established. The main input terminal obtains input information from the relay device. The input information is received at an auxiliary input terminal and is sent from the auxiliary input terminal to the relay device. The input information is displayed at an input position on the main input terminal. In this way, if the screen size of the main input terminal is relatively small or the input manner is not suitable for quick entering of information, a user can perform inputting on the auxiliary input terminal which supports convenient and fast input. The information input into the auxiliary input terminal can be automatically displayed at the input position on the main input terminal. Thus, input difficulties in the main input terminal are lowered, thereby improving efficiency in inputting information.

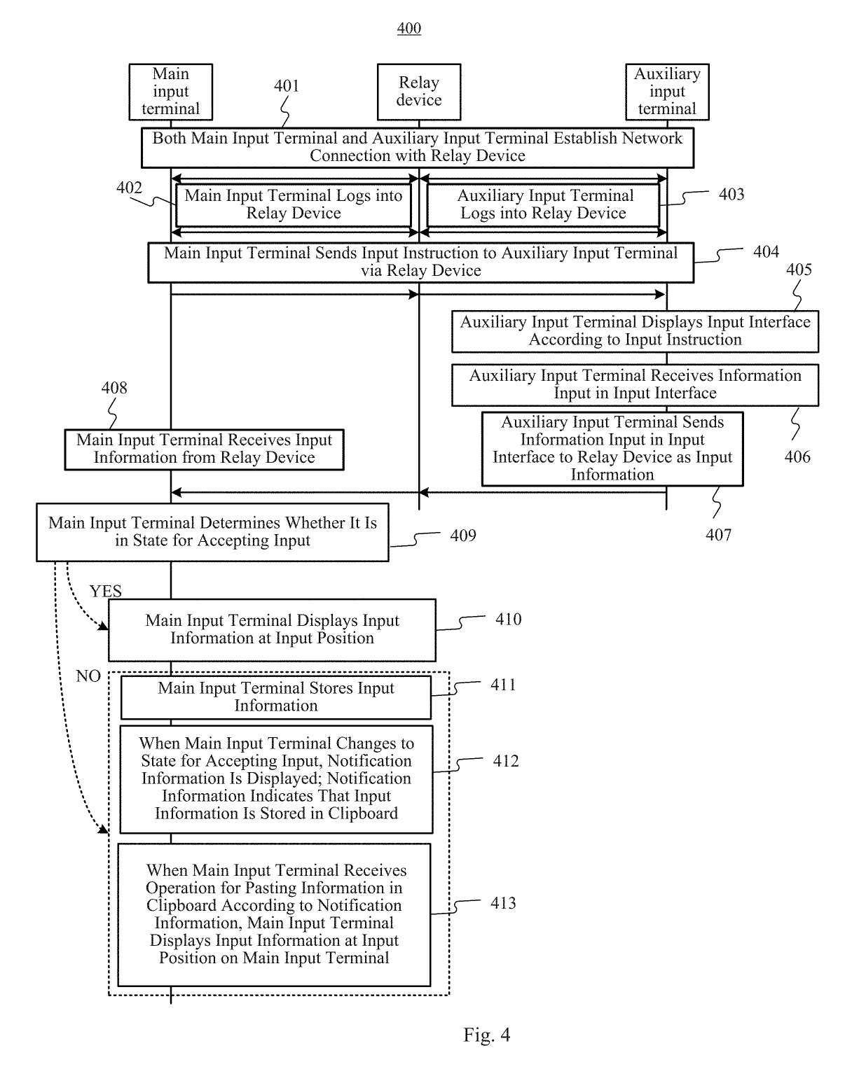

FIG. 4 is a flow chart of a method 400 for inputting information, according to another exemplary embodiment. The method 400 can be applied in the implementation environment 100 described in connection with FIG. 1. Referring to FIG. 4, the method 400 can include the following steps.

In step 401, both the main input terminal and the auxiliary input terminal establish a network connection with the relay device.

In step 402, the main input terminal logs into the relay device using a first account.

In step 403, the auxiliary input terminal logs into the relay device using a second account. The first account and the second account can be the same one, or the first account and the second account are bound or associated with each other.

Details about the login procedure in the main input terminal and the auxiliary input terminal can be found in the above descriptions regarding steps 301 to 303 (FIG. 3), and will not be repeated here.

In step 404, the main input terminal sends an input instruction to the auxiliary input terminal via the relay device.

Correspondingly, the auxiliary input terminal can receive the input instruction sent from the main input terminal via the relay device. When the main input terminal changes to the state for accepting input, the main input terminal can send the input instruction to the auxiliary input terminal. For example, when the user taps or clicks the input position such as an input box, the operating system in the main input terminal can receive an input focus request, and then the operating system controls the main input terminal to change to the state for accepting input. Meanwhile, the main input terminal sends the input instruction to the auxiliary input terminal via the relay device.

In step 405, the auxiliary input terminal displays an input interface according to the input instruction.

The input interface can be an interface displayed in an APP installed in the auxiliary input terminal, such that input can be performed via the interface. For example, the input interface can be an input box displayed in an interface of the APP.

In step 406, the auxiliary input terminal receives information input in the input interface.

In step 407, the auxiliary input terminal sends the information input in the input interface to the relay device as input information to be input into the auxiliary input terminal.

In step 408, the main input terminal receives the input information from the relay device.

The procedure for the main input terminal to receive the input information from the auxiliary input terminal in steps 406 to 408 can be found from the descriptions regarding step 304 (FIG. 3) and will not be repeated here.

In step 409, the main input terminal determines whether the main input terminal itself is in the state for accepting input. If the main input terminal is in the state for accepting input, step 410 is performed; if the main input terminal is not in the state for accepting input, steps 411 to 413 are performed.

In step 410, the main input terminal displays the input information at the input position on the main input terminal.

In step 411, the main input terminal stores the input information in a clipboard.

The present disclosure does not impose specific limitations on the capacity and number of pieces of information in the clipboard. The clipboard can store the most recently received piece of input information, or multiple pieces of input information.

According to an exemplary embodiment, the number of pieces of input information which can be stored in the clipboard in the main input terminal can be set depending on actual application needs. For example, it can be defined that the clipboard in the main input terminal can cache a maximum of ten pieces of input information. It should be noted that the exemplary embodiment in the step is only for explaining one of the scenarios that the step can be realized, but not for limiting the scope of the step.

In step 412, when the main input terminal changes to the state for accepting input, notification information is displayed. The notification information is used to notify that the input information is stored in the clipboard.

The notification information can be displayed using a drop-down box. For example, the main input terminal can display a drop-down box which can include the input information stored in the clipboard in step 411. For example, the clipboard stores three pieces of input information, i.e., M1, M2, and M3, and the drop-down box can display the contents of the three pieces of information M1, M2, and M3. The drop-down box can display all of the contents of each piece of input information stored in the clipboard. If some pieces of information contains too many contents, a part of the contents of the pieces of input information can be displayed. For example, only the first ten characters can be displayed. In addition, the notification information can be displayed in other manners. For example, the notification information can be displayed using a window, and embodiments of the present disclosure do not impose specific limitations on this.

Further, it can be defined according to usage needs that the input information stored in the clipboard can be deleted after it is used. If it is desired to maintain the input information, the input information can be locked. The locked input information can be used for any times. Afterwards, if the locked information is not needed any more, the locked input information can be deleted.

In step 413, when the main input terminal receives an operation for pasting information in the clipboard according to the notification information, the main input terminal displays the input information at the input position on the main input terminal.

In method 400, a network connection between a main input terminal and a relay device is established. The main input terminal obtains input information from the relay device. The input information is input into an auxiliary input terminal and is sent from the auxiliary input terminal to the relay device. The input information is displayed at an input position on the main input terminal. In this way, if the screen size of the main input terminal is relatively small or the input manner is not suitable for quick entering of information, a user can perform inputting in the auxiliary input terminal which supports convenient and fast input. The information input into the auxiliary input terminal can be automatically displayed at the input position on the main input terminal. Thus, input difficulties in the main input terminal are lowered, thereby improving efficiency in inputting information.

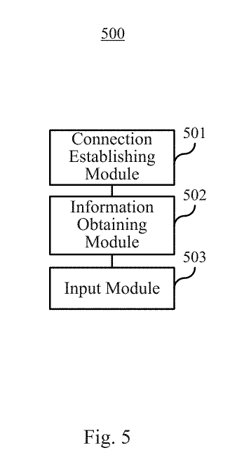

FIG. 5 is a block diagram of a device 500 for inputting information, according to an exemplary embodiment. The device 500 can be implemented as the main input terminal in the implementation environment 100 described in connection with FIG. 1 by hardware, or software, or a combination thereof so as to perform whole or a part of the steps performed by the main input terminal in any one of the embodiments as shown in FIGS. 2 to 4. Referring to FIG. 5, the device 500 can include a connection establishing module 501, an information obtaining module 502, and an input module 503.

The connection establishing module 501 is configured to establish a network connection with a relay device.

The information obtaining module 502 is configured to obtain from the relay device input information. The input information is received at an auxiliary input terminal and is sent from the auxiliary input terminal to the relay device.

The input module 503 is configured to display the input information obtained from the information obtaining module 502 at an input position on a main input terminal.

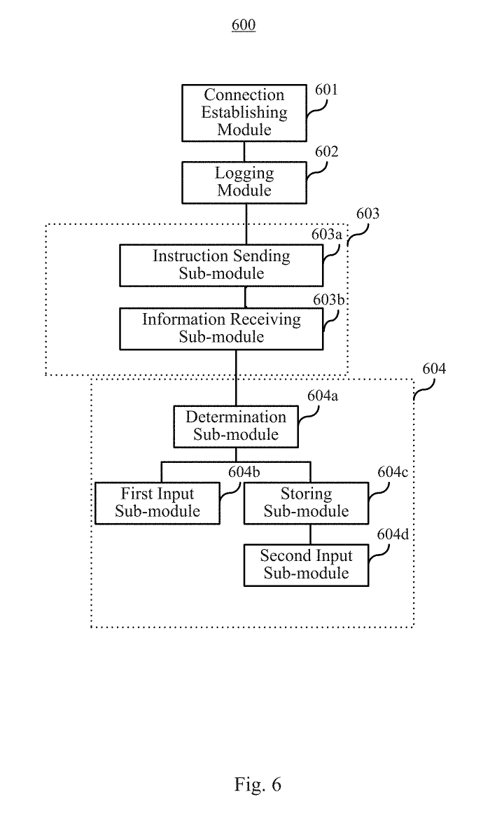

FIG. 6 is a block diagram of a device 600 for inputting information, according to another exemplary embodiment. The device 600 can be implemented as the main input terminal in the implementation environment 100 described in connection with FIG. 1 by hardware, or software, or a combination thereof so as to perform whole or a part of the steps performed by the main input terminal in any one of the embodiments as shown in FIGS. 2 to 4. Referring to FIG. 6, the device 600 can include a connection establishing module 601, a logging module 602, an information obtaining module 603, and an input module 604.

The connection establishing module 601 is configured to establish a network connection with a relay device.

The logging module 602 is configured to, before the information obtaining module obtains input information from the relay device, log into the relay device using a first account. The first account is the same with, or associated with, a second account, which is an account for the auxiliary input terminal to log into the relay device.

The information obtaining module 603 is configured to obtain from the relay device the input information. The input information is received at an auxiliary input terminal and is sent from the auxiliary input terminal to the relay device.

The information obtaining module 603 includes an instruction sending sub-module 603a and an information receiving sub-module 603b.

The instruction sending sub-module 603a is configured to send an input instruction to the auxiliary input terminal via the relay device. The input instruction is configured to instruct the auxiliary input terminal to display an input interface to accept the information input in the input interface, and to send the information to the relay device.

The information receiving sub-module 603b is configured to receive the input information from the relay device.

The input module 604 is configured to display the input information obtained from the information obtaining module 603 at an input position on a main input terminal.

The input module 604 includes a determination sub-module 604a, a first input sub-module 604b, a storing sub-module 604c, and a second input sub-module 604d.

The determination sub-module 604a is configured to determine whether the main input terminal is in a state for accepting input.

The first input sub-module 604b is configured to, if the determination sub-module 604a determines that the main input terminal is in the state for accept input, display the input information obtained by the information obtaining module 603 at the input position on the main input terminal.

The storing sub-module 604c is configured to, if the determination sub-module 604a determines that the main input terminal is not in the state for accepting input, store the input information obtained by the information obtaining module 603 in the main input terminal.

The second input sub-module 604d is configured to, when the main input terminal changes to the state for accepting input later, display the input information stored by the storing sub-module 604c at the input position on the main input terminal.

According to an exemplary embodiment, the storing sub-module 604c is configured to, if it is determined that the main input terminal is not in the state for accepting input, store the input information obtained by the information obtaining module 603 in a clipboard in the main input terminal.

The second input sub-module 604d is configured to: when the main input terminal changes to the state for accepting input at a later time, display notification information to notify that the input information is stored in the clipboard; and when receiving an operation for pasting information in the clipboard according to the notification information, display the input information at the input position on the main input terminal.

With respect to the devices in the above embodiments, the specific manners for performing operations for individual modules or sub-modules therein have been described in detail in the embodiments regarding the methods, which will not be repeated herein.

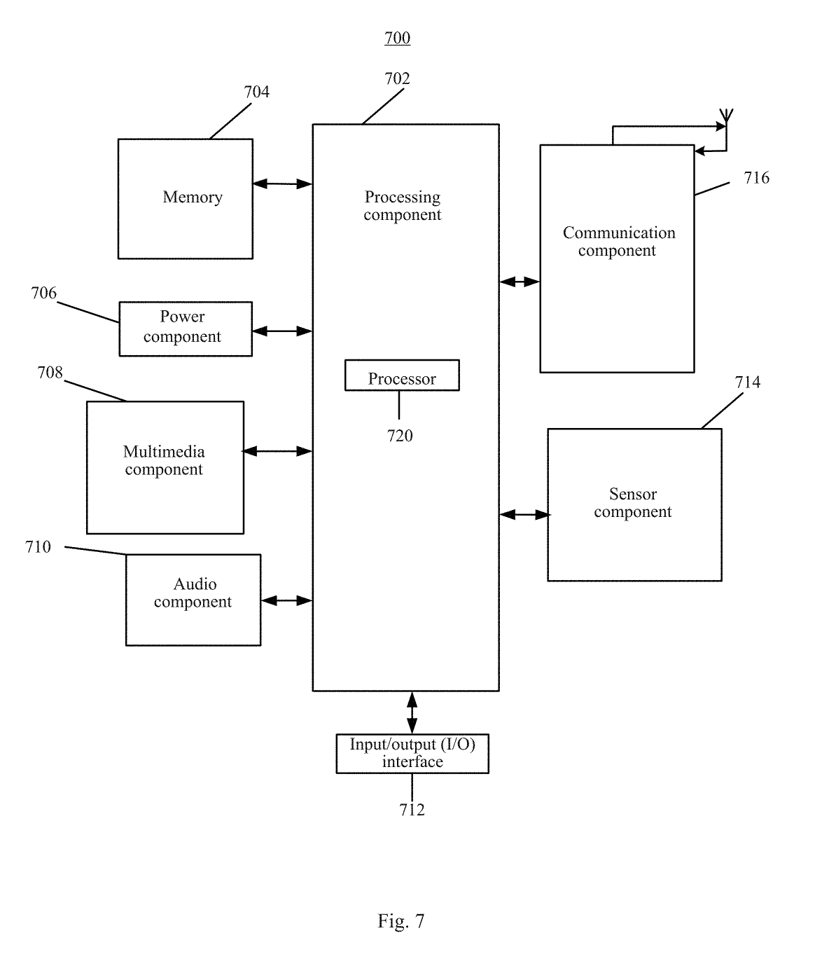

FIG. 7 is a block diagram of a device 700, according to an exemplary embodiment. For example, the device 700 may be a main input terminal as described above. In some embodiments, the device 700 may be an electronic device such as a smart phone, a wearable device, a smart TV or a vehicle-mounted terminal.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the device 700, such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the device 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect an open/closed status of the device 700, relative positioning of components, e.g., the display and the keypad, of the device 700, a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 2G, 3G,or 4G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods for online payment.

In exemplary embodiments, there is also provided a non-transitory computer-readable storage medium including instructions, such as included in the memory 704, executable by the processor 720 in the device 700, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for inputting information, comprising:
establishing a network connection with a relay device;
obtaining input information from the relay device, wherein the input information is received at an auxiliary input terminal and is sent from the auxiliary input terminal to the relay device; and
displaying the input information at an input position on a main input terminal.

2. The method according to claim 1, wherein displaying the input information at an input position on the main input terminal comprises:
determining whether the main input terminal is in a state for accepting input; and
if it is determined that the main input terminal is in the state for accept input, displaying the input information at the input position on the main input terminal.

3. The method according to claim 2, further comprising:
if it is determined that the main input terminal is not in the state for accepting input, storing the input information in the main input terminal; and
when the main input terminal changes to the state for accepting input at a later time, displaying the stored input information at the input position on the main input terminal.

4. The method according to claim 3, wherein storing the input information in the main input terminal if it is determined that the main input terminal is not in the state for accepting input comprises:
if it is determined that the main input terminal is not in the state for accepting input, storing the input information in a clipboard in the main input terminal;
wherein displaying the stored input information at the input position on the main input terminal when the main input terminal changes to the state for accepting input at a later time comprises:
when the main input terminal changes to the state for accepting input at a later time, displaying notification information to notify that the input information is stored in the clipboard; and
when receiving an operation for pasting information in the clipboard according to the notification information, displaying the input information at the input position on the main input terminal.

5. The method according to claim 1, further comprising:
before the input information is obtained from the relay device, logging into the relay device using a first account, wherein the first account is the same with, or associated with, a second account, and the second account is an account for the auxiliary input terminal to log into the relay device.

6. The method according to claim 1, wherein obtaining the input information from the relay device comprises:
sending an input instruction to the auxiliary input terminal via the relay device, wherein the input instruction is configured to instruct the auxiliary input terminal to display an input interface to accept information input in the input interface as the input information, and to send the input information to the relay device; and
receiving the input information from the relay device.

7. A device, comprising:
a processor; and
a memory for storing instructions executable by the processor;
wherein the processor is configured to:
establish a network connection with a relay device;
obtain input information from the relay device, wherein the input information is received at an auxiliary input terminal and is sent from the auxiliary input terminal to the relay device; and
display the input information at an input position on a main input terminal.

8. The device according to claim 7, wherein the processor is further configured to:
determine whether the main input terminal is in a state for accepting input; and
if it is determined that the main input terminal is in the state for accept input, display the input information at the input position on the main input terminal.

9. The device according to claim 8, wherein the processor is further configured to:
if it is determined that the main input terminal is not in the state for accepting input, store the input information in the main input terminal; and
when the main input terminal changes to the state for accepting input at a later time, display the stored input information at the input position on the main input terminal.

10. The device according to claim 9, wherein the processor is configured to:
if it is determined that the main input terminal is not in the state for accepting input, store the input information in a clipboard in the main input terminal; and
when receiving an operation for pasting information in the clipboard according to the notification information, display the input information at the input position on the main input terminal.

11. The device according to claim 7, wherein the processor is further configured to:
before the input information is obtained from the relay device, log into the relay device using a first account, wherein the first account is the same with, or associated with, a second account, and the second account is an account for the auxiliary input terminal to log into the relay device.

12. The device according to claim 7, wherein the processor is configured to:
send an input instruction to the auxiliary input terminal via the relay device, wherein the input instruction is configured to instruct the auxiliary input terminal to display an input interface to accept the information input in the input interface as the input information, and to send the input information to the relay device; and
receive the input information from the relay device.

13. A non-transitory computer-readable storage medium having stored therein instructions that, when executed by a processor of a main input terminal, cause the main input terminal to perform a method for inputting information, the method comprising:
establishing a network connection with a relay device;
obtaining input information from the relay device, wherein the input information is received at an auxiliary input terminal and is sent from the auxiliary input terminal to the relay device; and
displaying the input information at an input position on the main input terminal.
